(19) United States
(12) Patent Application Publication
(10) Pub. No.: US 2007/0002875 A1
(43) Pub. Date: Jan. 4, 2007

(54) Apparatus, system, and methods for status monitoring and control of cable television network components

(75) Inventors: Joseph D. Rocci, Lansdale, PA (US); Michael L. Quelly, Quakertown, PA (US)

Correspondence Address: STERNE, KESSLER, GOLDSTEIN & FOX PLLC, 1100 NEW YORK AVENUE, N.W., WASHINGTON, DC, 20005, US

(73) Assignee: NeST Technologies, Inc., Chantilly, VA (US)

(21) Appl. No.: 11/112,006

(22) Filed: Apr. 22, 2005

Related U.S. Application Data
(60) Provisional application No. 60/564,230, filed on Apr. 22, 2004.

(51) Int. Cl. H04L 12/56

(52) U.S. Cl. 370/401; 370/466

(57) ABSTRACT

Apparatus, systems, and methods to cost effectively monitor and control distributed devices within a cable television network are disclosed. In particular, a gateway transponder and a device transponder are provided. A device transponder can be associated with a device other than a power supply located in a cable television network. The device transponder provides an efficient mechanism for exchanging control messages between a device where the transponder resides and a network operator management system. A gateway transponder can be associated with a network power supply. A gateway transponder serves as a gateway between a network operator management system and a set of device transponders. In a further feature of the present invention, a very simplified management protocol is provided that simplifies Simple Network Management Protocol (SNMP) messaging and reduces the size of management messages that are exchanged between a gateway transponder and a device transponder.

### CROSS REFERENCE TO RELATED APPLICATIONS

The present application claims the benefit of the filing dates of U.S. Provisional Patent Application No. 60/564,230, filed Apr. 22, 2004, which is incorporated by reference herein in its entirety.

### BACKGROUND OF THE INVENTION

1. Field of Invention

The present invention relates to communication transmission networks, and more particularly to cable television transmission networks.

2. Related Art

In a cable television transmission network, radio frequency signals are transmitted bi-directionally between a plurality of subscriber premises and a central headend facility. The bi-directional capability is achieved using a frequency division multiplexing method wherein signals higher than approximately 50 MHz propagate toward subscriber homes and signals lower than approximately 40 MHz propagate toward the headend. These transmission networks commonly employ a hybrid fiber-coax (HFC) architecture, with fiber optic cables used for long distance trunks, and coaxial cable employed for the feeders that run through the neighborhoods served by the network. The coaxial cables also carry a low frequency AC voltage that powers the active network elements that are installed in the coaxial distribution network.

Specifically, 60 to 90 volt power signals are carried within a coaxial cable to provide power in cable television networks. Network power supplies that are distributed throughout a cable television network provide this power to amplifiers, optical nodes and other components. Power blocks or other means are used to segment the power, such that each power supply powers only a portion of the network equipment and is isolated from other network power supplies. Within a cable television network, there are often many power segments.

Transponders have been developed and deployed to monitor and control cable television network power supplies. A transponder is a telemetry device used to exchange management and control information between a management system and a managed device. Transponders are generally located within network power supplies, and employ a variety of communication protocols that allow cable operators to monitor the power supplies from an operations office, typically located at a cable headend. The protocols used include proprietary protocols, a Hybrid Management Sublayer (HMS) protocol, and Data Over Cable Service Interface Specification (DOCSIS). HMS is a set of protocols, management information bases (MIBs), and other specifications standardized by the Society of Cable Telecommunications Engineers to provide remote management of cable television network equipment. DOCSIS is a collection of specifications developed by Cable Television Laboratories that describe protocols and procedures for providing Internet, telephony, video on demand, and other data services over a cable television network. DOCSIS and HMS standards are in wide use throughout the cable industry.

Similarly, a wide range of transponders have been developed and deployed for monitoring amplifiers, optical nodes, and other active devices within a cable television network. These transponders use proprietary legacy communications protocols, as well as standards-based status monitoring protocols, such as HMS. The use of these legacy proprietary and HMS status monitoring protocols in amplifiers and optical nodes has several significant drawbacks that make their use unattractive to network operators, including the need for expensive headend controllers, slow data communications performance, and high cost.

Moreover, network providers have widely deployed DOCSIS capabilities in their networks. A status monitoring transponder that interoperates with the existing DOCSIS infrastructure can be developed. However, deployment of such a transponder throughout all components within a cable network would result in larger device size, increased power consumption, and higher network costs. While cost effective to place a DOCSIS status monitoring transponder in network power supplies, it is not cost effective to deploy a DOCSIS status monitoring transponder in each of the amplifiers, optical nodes and other components that are distributed throughout a cable network.

What is needed is a cost effective apparatus, system, and methods for active monitoring and control of network components distributed throughout a cable television network.

### SUMMARY OF THE INVENTION

The present invention provides apparatus, systems, and methods to cost effectively monitor and control distributed devices within a cable television network. In particular, a gateway transponder and a device transponder are provided. A device transponder can be associated with a device other than a power supply located in a cable television network. The device transponder provides an efficient mechanism for exchanging control messages between a device where the transponder resides and a network operator management system. A gateway transponder can be associated with a network power supply. A gateway transponder serves as a gateway between a network operator management system and a set of device transponders.

A gateway transponder serves to receive messages using the DOCSIS protocol from a network operator's management system and translate those messages using a management layer protocol and a protocol for low frequency signaling on power lines, such as X10, for transmittal to a device transponder. Similarly, a gateway transponder can receive messages from a device transponder using the X10 protocol and translate those messages into a DOCSIS format for transmittal to a network operator's management system. In other embodiments, power line protocols supporting low frequency signaling, other than the X10 protocol, can be used. In further embodiments, messages could be transmitted on the radio frequency (RF) channel of the cable TV coaxial cable using an RF signaling protocol.

In a further feature of the present invention, a very simplified management protocol is provided that simplifies Simple Network Management Protocol (SNMP) messaging. This protocol, referred to herein as vSNMP for very simplified network management protocol, reduces the size of management messages that are exchanged between a gateway transponder and a device transponder.

There are numerous advantages to the present invention. One advantage is the reduction or elimination of expensive and complex proprietary monitoring system headend controllers that currently support transponders in cable television networks. Furthermore, the present invention supports complete cable television network monitoring via existing DOCSIS infrastructure without the need for specialized proprietary software. Finally, inexpensive power line carrier technology can be used with device transponders, where cost, space and power are restricted. Thereby, enabling network operators to deploy DOCSIS hardware and technology—which is typically more expensive and complex—only where needed.

Further embodiments, features, and advantages of the present inventions, as well as the structure and operation of the various embodiments of the present invention, are described in detail below with reference to the accompanying drawings.

### BRIEF DESCRIPTION OF THE FIGURES

FIG. 1 is a diagram of a portion of a cable television network.

FIG. 2 is a diagram of a gateway transponder, according to an embodiment of the present invention.

FIG. 3 is a diagram of a device transponder, according to an embodiment of the present invention.

FIG. 4 is a diagram of a portion of a cable television network, according to an embodiment of the present invention.

FIG. 5 is a flowchart of a method to transmit control messages to a cable TV network device, according to an embodiment of the present invention.

FIG. 6 is a flowchart of a method to receive control messages from a cable TV network device, according to an embodiment of the present invention.

FIG. 7 is a chart that presents example vSNMP message formats that can be used for communicating between transponders, according to an embodiment of the present invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

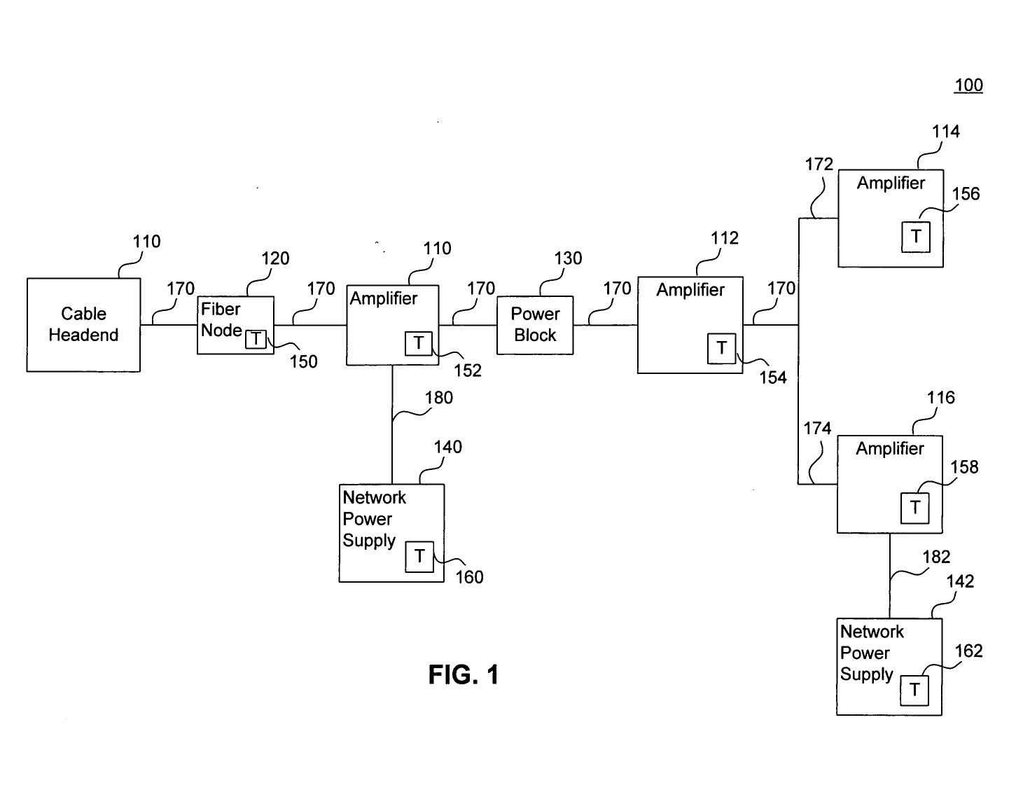

FIG. 1 illustrates a portion of a typical cable television network. The example cable television network portion shown consists of cable headend 110, fiber node 120; amplifiers 110, 112, 114 and 116; network power supplies 140 and 142 and power block 130. Additional devices, such as splitters, taps and additional feeder distribution networks to customer premises are not illustrated for simplicity. A cable television signal can be transmitted over fiber optic cable 170 through the devices to multiple end user subscribers (not shown).

Throughout a cable television network, network power supplies are distributed to supply power to the active devices. Network power supplies provide power to power segments that are segmented by the insertion of power blocks, such as power block 130, within a cable network. The creation of power segments enables cable operators to more effectively manage their networks. In the present example two power segments are illustrated. In one segment, network power supply 140 is electrically coupled to amplifier 110 via transmission path 180. Network power supply 140 also provides power to fiber node 120 over fiber optic cable 170. Power block 130 forms the boundary for the power segment and prevents network power supply 140 from providing power to amplifiers 112, 114 and 116. In the second segment, power is supplied to amplifiers 112, 114 and 116 by network power supply 142. Network power supply 142 is electrically coupled to amplifier 116 via transmission path 182. Fiber optic cables 170, 172 and 174 enable power to be distributed to amplifiers 112 and 114 from network power supply 142.

Transponders are used within devices in a cable television network to exchange control messages used to monitor and manage the devices within a network. In the example depicted in FIG. 1, fiber node 120 contains transponder 150, amplifier 110 contains transponder 152, amplifier 112 contains transponder 154, amplifier 114 contains transponder 156, amplifier 116 contains transponder 158, network power supply 140 contains transponder 160 and network power supply 142 contains transponder 162. A management system (not pictured) provides control messages that are exchanged with the transponders to monitor and manage the devices coupled to the transponders.

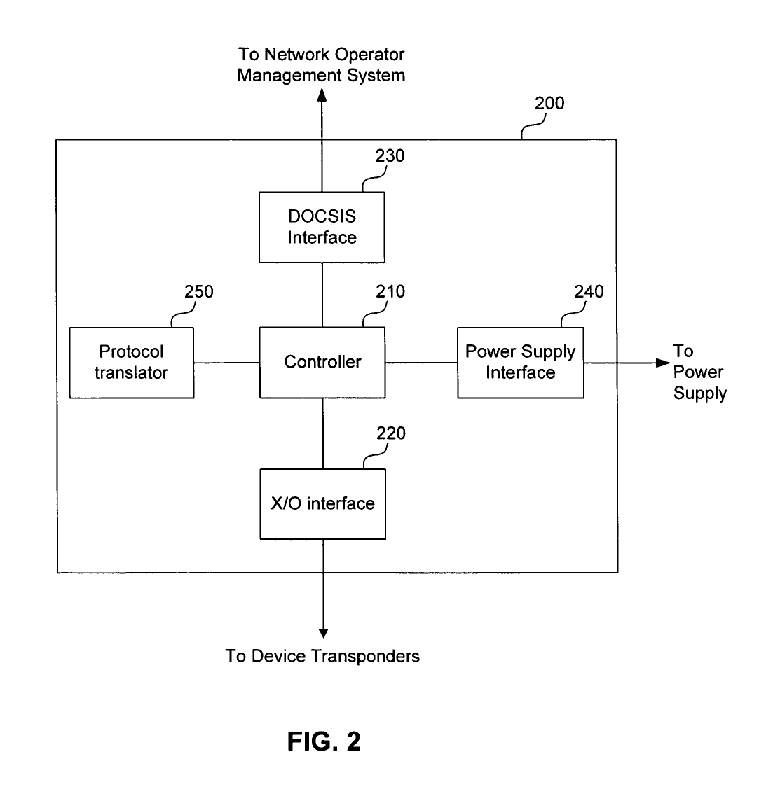

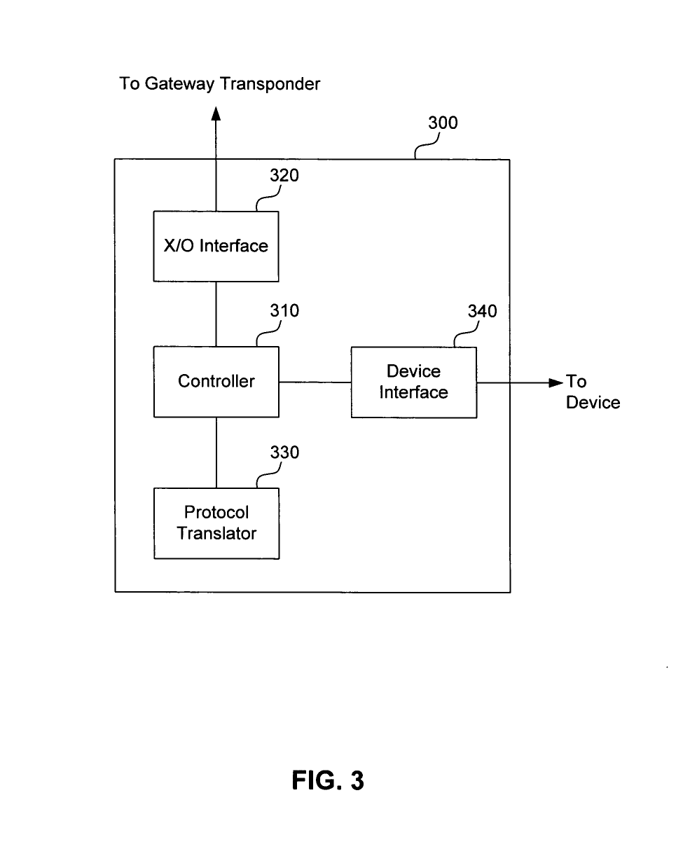

FIG. 2 is a diagram of a gateway transponder 200, according to an embodiment of the present invention. A gateway transponder would reside within or near a network power supply. A gateway transponder serves a gateway between a cable operator's management system and a set of device transponders, as discussed with reference to FIG. 3. The gateway transponder also facilitates remote management and control of the network power supply where the gateway transponder is located.

Gateway transponder 200 includes controller 210, X10 interface 220, DOCSIS interface 230, power supply interface 240 and protocol translator 250. Controller 210 is coupled to each of the other components 220-250. Controller 210 manages the operation of gateway transponder 200 and facilitates the transfer and interpretation of messages that are exchanged. X10 interface 220 provides an interface between controller 210 and communications paths to device transponders that are coupled to devices distributed within a cable television network, as discussed more completely with reference to FIG. 3. In other embodiments, alternative types of power signaling protocol interfaces can be used. For example, in one embodiment a power line modem, such as the TDA5051 or TDA5051 produced by Philips Semiconductor, can be used to support signaling on the power line carrier. These modems use amplitude phase shift keying technology. In further embodiments, an interface that uses the RF channel of a cable television coaxial cable can be used. Because the RF channel is directional, frequencies must be selected for use to avoid challenges raised by the directional nature of the RF channel.

X10 is an industry standard protocol for transmitting messages over power lines. The technology uses high frequencies to transmit messages over a power network. X10 technology is commonly used in home automation implementations. Integrated circuits, designed for consumer products supporting the X10 protocol are readily available. Transponders using X10 technology can be made at much lower costs than with traditional status monitoring transponder technology. In other embodiments of the present invention, a different interface can be used that supports other protocols to exchange messages over power lines, such as the protocols used with the TDA5051 power line modems.

DOCSIS interface 230 provides an interface between controller 210 and a communications path to a network operator's management systems.

Protocol translator 250 is coupled to controller 210. Protocol translator 210 can be used to translate DOCSIS messages received from a management system to a simplified management protocol. Typically, a management system will employ robust protocols such as TCP/IP or simple network management protocol (SNMP). While robust, these protocols can carry excessive overhead. Thus, protocol translator 250 can be used to translate complex DOCSIS messages received using a TCP/IP or SNMP protocol to a simplified message. X10 technology and, in general, communications over power lines often supports only a low bandwidth for data communications. Thus, protocol translator 210 can provide a valuable function of reducing the message size of messages to be transmitted to devices over a power line to improve system performance.

Power supply interface 240 is coupled to controller 210 and to a network power supply device. Power supply interface 240 enables gateway transponder 200 to exchange control messages to monitor and manage the network power supply, where the gateway transponder resides.

FIG. 3 is a diagram of a device transponder 300, according to an embodiment of the present invention. A device transponder would be associated with an individual device (e.g., node, amplifier, etc.) within a cable television network. A device transponder would facilitate monitoring and management of the device associated with the device transponder. Device transponder 300 consists of controller 310, X10 interface 320, protocol translator 330 and device interface 340.

Controller 310 is coupled to each of the other components 320-340. Controller 310 manages the operation of device transponder 300 and facilitates the transfer and interpretation of messages that are exchanged. X10 interface 320 provides an interface between controller 310 and a communications path to a gateway transponder. In other embodiments, alternative types of power signaling protocol interfaces can be used. For example, in one embodiment a power line modem, such as the TDA5051 or TDA5051 produced by Philips Semiconductor, can be used to support signaling on the power line carrier. These modems use amplitude phase shift keying technology. In further embodiments, an interface that uses the RF channel of a cable television coaxial cable can be used. Because the RF channel is directional, frequencies must be selected for use to avoid challenges raised by the directional nature of the RF channel.

Protocol translator 330 is coupled to controller 310. Protocol translator 330 can be used to translate control messages received from a management system and to format messages into a simplified management protocol for transmission.

Device interface 340 is coupled to controller 310 and to a device where the device transponder resides. Device interface 340 enables gateway transponder 200 to exchange control messages to monitor and manage the device, where the device transponder resides.

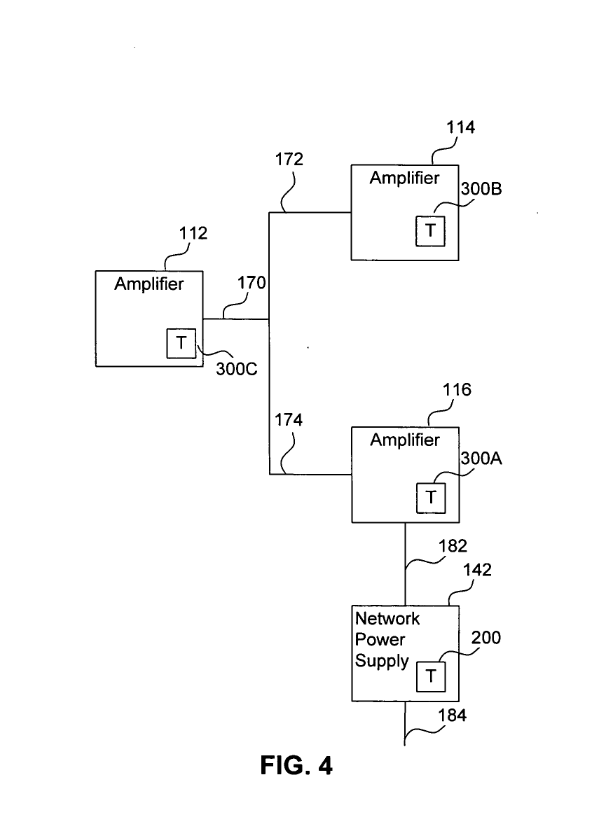

FIG. 4 is a diagram of a portion of a cable television network, according to an embodiment of the present invention. FIG. 4 illustrates a portion of the network that was illustrated in FIG. 1 that includes the second power segment. In the second power segment, network power supply 142 provides power to amplifiers 112, 114 and 116. In FIG. 4, gateway transponder 200 has been associated with network power supply 142. Additionally, a device transponder 300 has been associated with each of amplifiers 112, 114 and 116. These are depicted as device transponder 300A, 300B and 300C. In one embodiment, management messages would be provided to gateway transponder 200 from a management system via transmission path 184 using a DOCSIS message format. Gateway transponder 200 would then determine to which transponder the message should be routed. Assuming that the message should be routed to transponder 300A, gateway transponder 200 would convert the message from a DOCSIS message to a message using the X10 protocol. In one embodiment, the gateway transponder can also translate the message into a simplified message using a very simplified network management protocol. Gateway transponder 200 then transmits the message to device transponder 300A, and device transponder 300A takes the appropriate action upon receipt of the message.

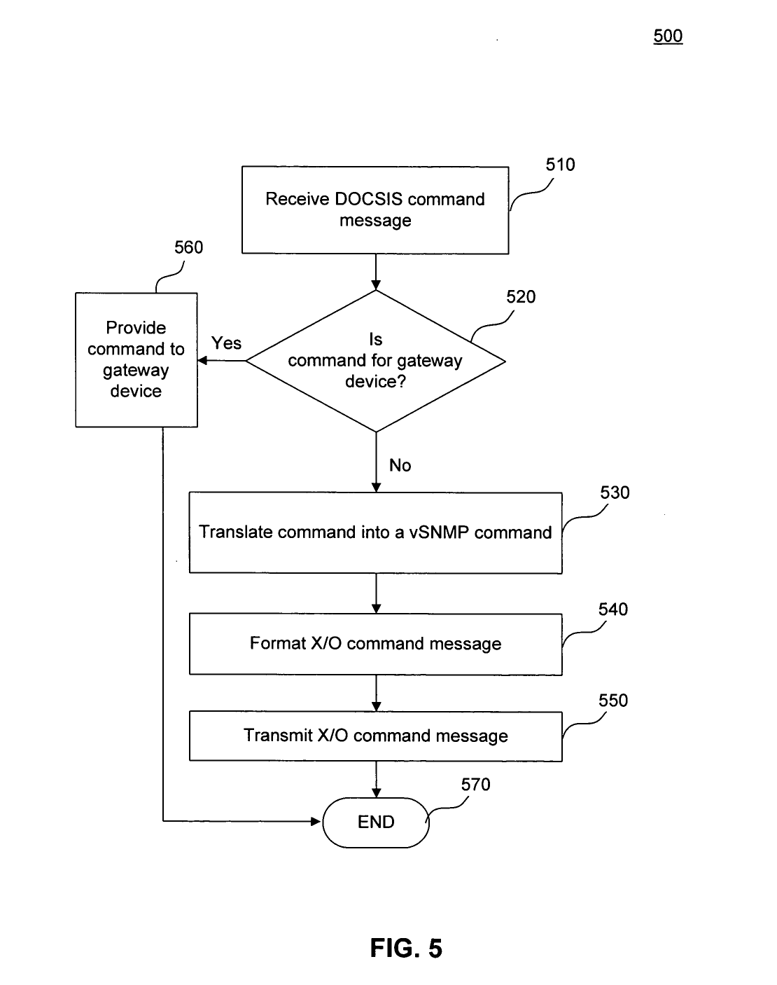

FIG. 5 is a flowchart of a method 500 to transmit control messages to a cable TV network device, according to an embodiment of the present invention. Method 500 would be implemented by a gateway transponder, such as gateway transponder 200, to transmit control messages received from a management system to device transponders, such as device transponder 300.

Method 500 begins in step 510. In step 510, a DOCSIS command message is received. For example, a gateway transponder, such as gateway transponder 300 can receive the DOCSIS command message. In step 520, a determination is made whether the command is for a network power supply associated with the gateway transponder or for another device. If the command is for the power supply associated with the gateway transponder, the command is provided to the network power supply. The method proceeds to step 570 and ends.

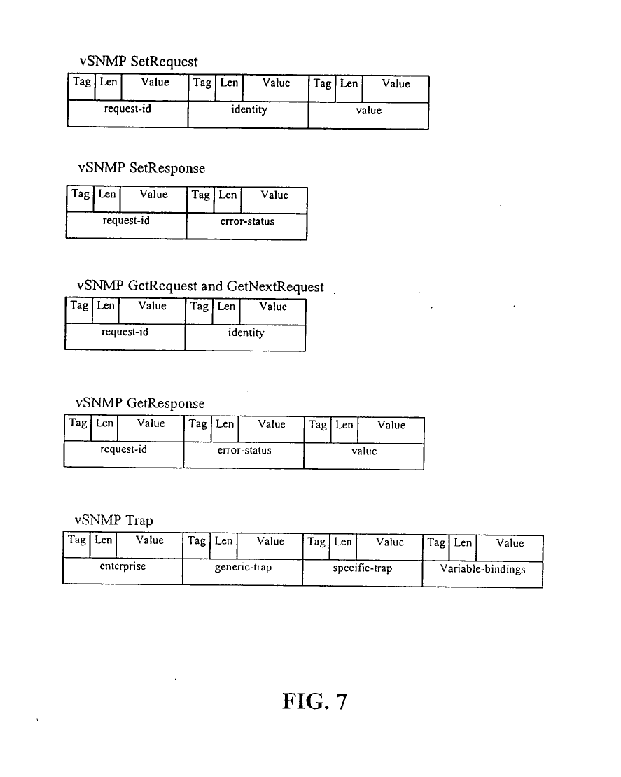

If the command is for a device other than the network power supply associated with the gateway transponder, then the method proceeds to step 530. In step 530, the command is converted to a vSNMP command. Additional details regarding the vSNMP protocol are discussed below with reference to FIG. 7. vSNMP stands for very simplified network managing protocol. vSNMP command protocol maps the standard SNMP management information bases (MIBs) and enables generic transponder firmware to be developed which is capable of handling a wide variety of nodes and amplifiers, according to an embodiment of the present invention. A MIB is a standardized way of describing a collection of objects within SNMP. A vSNMP message may contain only a single varBind, and the object identifiers (OIDs) are truncated upward from the enterprise branch. Additionally, all extraneous message components are removed. In other embodiments of method 500, a different simplified management protocol may be used or this step may be skipped altogether.

In step 540, the command message is formatted using the X10 protocol. In another embodiment, a different type of protocol for use on power lines can be used such as those supported by the TDA5051 power line modem. In further embodiments, the message can be formatted using a signaling protocol appropriate for signaling on the RF channel of the cable TV coaxial cable.

In step 550, the gateway transponder transmits the X10 command message to the appropriate device transponder. Alternatively, a command message using a different signaling protocol, such as one supported by the TDA5051 power line modem can be used. In step 570, method 500 ends.

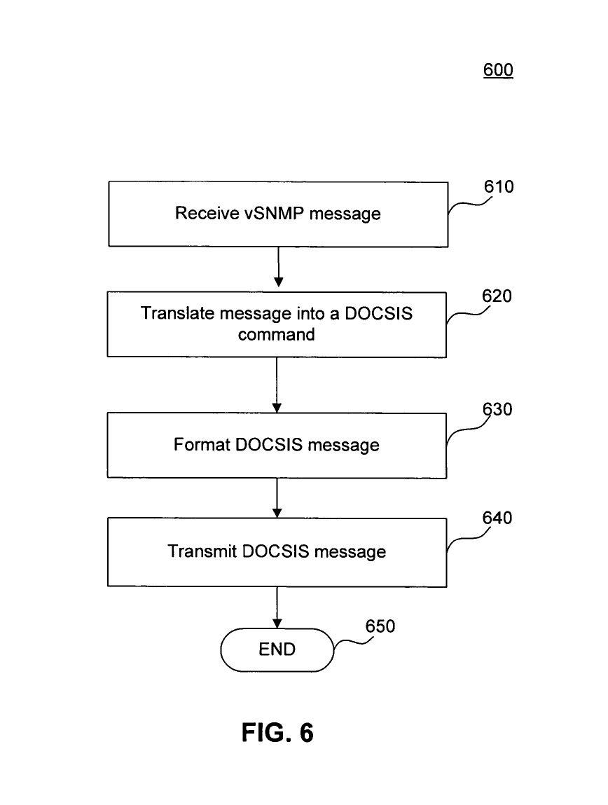

FIG. 6 is a flowchart of a method 600 to receive control messages from a cable TV network device, according to an embodiment of the present invention. Method 600 would be implemented by a gateway transponder, such as gateway transponder 300 that receives messages from device transponders, such as device transponder 200

Method 600 begins in step 610. In step 610 a gateway transponder, such as gateway transponder 300 receives a vSNMP message using an X10 protocol from a device transponder, such as device transponder 200. In other embodiments, the vSNMP message using an X10 protocol could be a message using another type of power line communications protocol or RF signaling protocol and could be using a protocol another than vSNMP for conveying control information. In step 610, the gateway transponder translates the vSNMP message into a DOCSIS command. In step 630, the gateway transponder formats a DOCSIS message with the DOCSIS command. In step 640, the gateway transponder transmits the DOCSIS message to a network operator's management system, or other destination. In step 650, method 600 ends.

The present invention has been described with respect to example X10 interfaces and DOCSIS interfaces, however, this is not intended to limit the present invention. Other interfaces and protocols can be used.

FIG. 7 is a chart that provides example vSNMP message formats that can be used for communicating between transponders, according to an embodiment of the present invention. SNMP is a management protocol designed primarily to run on high speed communications networks. In high speed, multi-megabit, communications networks the relatively inefficient message structure can be easily justified by the flexibility provided by the SNMP protocol. However, communications bandwidth between a gateway transponder and another transponder can be as much as six orders of magnitude less than the bandwidth available on high speed networks. As a result use of an efficient protocol to maintain reasonable operating speeds is critical.

vSNMP provides an effective alternative to the use of SNMP. vSNMP leverages SNMP flexibility, while reducing the typical message length to one third of the standard SNMP messages. In part these reductions are attributed to reducing the security overhead within messages, which given the small closed network characteristics of the intended applications should not raise operating concerns. Furthermore, the use of short messages allow for more robust communications since the probability of getting a noise hit during a message is proportional to the time it takes to transmit the message.

Unlike SNMP, vSNMP is intended to operate in a polled mode where each request is followed by a response. The addressing and error handling is handled by the MAC layer protocol and is invisible to the vSNMP layer. There is no possibility of having two outstanding requests, making it unnecessary for the messages to be standalone. The program evaluating a response message has the benefit of knowing the request that produced the response. This is very different from SNMP where each message can be evaluated on a standalone basis. Furthermore, there are no unsolicited messages in vSNMP, and the MAC layer protocol provides for the delivery of traps from device transponders to a gateway transponder.

vSNMP messages are constructed using the SNMPv1, SMIv1 specification with the following changes:

All Messages
The initial Tag and Length are omitted, since the message length is provided by the MAC layer.
The Version field is omitted, since it is not required by the transponders.
The Community String field is omitted, since security is not an issue.

GetRequest
The error-status field is omitted, since it is always null.
The error-index field is omitted, since it is always null.
The variable-bindings field is omitted, since only a single VarBind is supported.
The value field is omitted, since it is always null.

GetResponse
The error-index field is omitted, since it is always null.
The variable-bindings field is omitted, since only a single VarBind is supported.
The identity field is omitted, since it is always the same as the request.

SetRequest
The error-status is omitted since it is always null.
The error-index is omitted, since it is always null.
The variable-bindings field is omitted, since only a single VarBind is supported.

SetResponse
The error-index is omitted, since there is only a single VarBind.
The variable-bindings field is omitted, since only a single VarBind is supported.
The VarBind is omitted, since a response with no error indicates the value was set correctly and there is only a single gateway to each transponder.
The identity field is omitted, since it is always the same as the request.
The value is omitted.

Traps
The agent address is omitted, since the IP address can be supplied only by the gateway.
The time-stamp is omitted since the time is supplied by the gateway transponder.

FIG. 7 provides a chart showing the format for the vSNMP SetRequest, SetResponse, GetRequest, GetNextRequest, GetResponse and trap messages.

### CONCLUSION

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof. Thus, the breadth and scope of the present invention should not be limited by any of the above-described exemplary embodiments, but should be defined only in accordance with the following claims and their equivalents.

What is claimed is:

1. A system for status monitoring and control of cable television network components with a cable television network, comprising:
a plurality of cable television network components;
at least one device transponder associated with a cable television network component within said plurality of cable television network components, wherein said at least one device transponder facilitates monitoring and management of the cable television network component; and
at least one gateway transponder associated with one of the cable television network components, wherein said at least one gateway transponder serves as a gateway between a cable operator's management system and a set of said at least one device transponders.

2. The system of claim 1, wherein said at least one device transponder, comprises:
a controller that manages operation of said at least one device transponder;
an X10 interface that provides an interface between said controller and the at least one gateway transponder;
a protocol translator that translates control messages received from the cable operator's management system into messages having a simplified management protocol; and
a device interface coupled to said controller and the cable television network component that the device transponder is associated with for monitoring and managing the cable television network component.

3. The system of claim 1, wherein said at least one gateway transponder, comprises:
a controller that manages operation of said at least one gateway transponder;
an X10 interface that provides an interface between said controller and communication paths to device transponders within said at least one device transponder;
a DOCSIS interface that provides an interface between the cable operator's management system and said controller;
a protocol translator that translates control messages received from the cable operator's management system into messages having a simplified management protocol; and
a device interface coupled to said controller and the cable television network component with which the gateway transponder is associated.

4. The system of claim 3, wherein the simplified management protocol comprises vSNMP, wherein the vSNMP protocol operates in a poll mode, wherein vSNMP messages are constructed using the SNMPv1, SMIv1 specification with the following changes:
All Messages
The initial Tag and Length are omitted, since the message length is provided by the MAC layer.
The Version field is omitted, since it is not required by the transponders.
The Community String field is omitted, since security is not an issue.
GetRequest
The error-status field is omitted, since it is always null.
The error-index field is omitted, since it is always null.
The variable-bindings field is omitted, since only a single VarBind is supported.
The value field is omitted, since it is always null.
GetResponse
The error-index field is omitted, since it is always null.
The variable-bindings field is omitted, since only a single VarBind is supported.
The identity field is omitted, since it is always the same as the request.
SetRequest
The error-status is omitted since it is always null.
The error-index is omitted, since it is always null.
The variable-bindings field is omitted, since only a single VarBind is supported.
SetResponse
The error-index is omitted, since there is only a single VarBind.
The variable-bindings field is omitted, since only a single VarBind is supported.
The VarBind is omitted, since a response with no error indicates the value was set correctly and there is only a single gateway to each transponder.
The identity field is omitted, since it is always the same as the request.
The value is omitted.
Traps
The agent address is omitted, since the IP address can be supplied only by the gateway.
The time-stamp is omitted since the time is supplied by the gateway transponder.

5. The system of claim 1, wherein each gateway transponder within said at least one gateway transponder is associated with a network power supply.

6. A method to transmit control messages to a cable TV network device, comprising:
(a) receiving a DOCSIS command message;
(b) determining whether the DOCSIS command is for a network power supply associated with a gateway transponder or for another device;
(c) when the DOCSIS command is for a device other than a network power supply, converting the DOCSIS command to a vSNMP command;
(d) formatting the vSNMP command using an X10 protocol; and
(e) transmitting the vSNMP command with the X10 protocol to a device transponder.

7. A method to receive control messages from a cable TV network device received by a gateway transponder from a device transponder, comprising:
(a) receiving a vSNMP message using an X10 protocol;
(b) translating the vSNMP message into a DOCSIS command;
(c) formatting a DOCSIS message based on the DOCSIS command; and
(d) transmitting the DOCSIS message to a network operator's management system.
